(19) United States
(12) Patent Application Publication
(10) Pub. No.: US 2015/0256564 A1
(43) Pub. Date: Sep. 10, 2015

(54) 4D Video & Media Effects Control System

(71) Applicant: Dustin Alan Reynolds, (US)

(72) Inventor: Dustin Alan Reynolds, (US)

(21) Appl. No.: 13/855,741

(22) Filed: Apr. 3, 2013

(51) Int. Cl. H04L 29/06; G05B 15/02

(52) U.S. Cl. CPC H04L 65/403; G05B 15/02

(57) ABSTRACT

This invention is a media controlled effects system, media controlled power supply, and software system that facilitates control of media presentations and external devices to produce effects corresponding with segments of media. The effects control signal, timing signals, and other media processing commands can be generated prior to media viewing or via real-time processing of visual, audio, and textual elements of the media presentation. Effect and command signals are processed by the hardware or software control system to provide power to, or otherwise control a media presentation or attached device. This invention accommodates control of ordinary devices to produce effects that make a media experience that is more enjoyable and can be comprised of both hardware and/or software achieve the desired result. The invention can be incorporated into other devices, function independently, or work in conjunction with other devices to provide or process either automated or manual control signals.

### CROSS-REFERENCE TO RELATED APPLICATIONS

This non-provisional application claims the benefit and application date of the provisional application previously filed under application number 61620223 filed on Apr. 4, 2012.

### STATEMENT REGARDING FEDERALLY SPONSORED RESEARCH OR DEVELOPMENT (NOT APPLICABLE)

None. NO federal funding was used.

### REFERENCE TO SEQUENCE LISTING, A TABLE, OR A COMPUTER PROGRAM LISTING COMPACT DISC APPENDIX (NOT APPLICABLE)

Not applicable.

### BACKGROUND OF THE INVENTION:

Present day televisions and projectors include features such as 3D to make the viewing experience more realistic. This invention takes two-dimensional and three-dimensional viewing experiences to the next level by facilitating the ability to better experience the scenes in a movie or media presentation. Windy scenes, rainy scenes, snowy scenes, earthquakes, pungent dungeons, flowery hills, and other scenes are able to better come to life with this invention. These experiences are available in 4D theaters today via special seating; however, homes, offices, and small theaters don't have affordable options for producing such effects. This invention provides a simple means of controlling the required effects while leaving the implementation of a desired effect open for experimentation and creative solutions. This invention also facilitates the removal, skipping, or modification of undesired scenes within a media presentation.

### BRIEF SUMMARY OF THE INVENTION

This invention controls power to various external devices to produce effects corresponding with scenes in a video or media presentation. For example, wind in a movie can be experienced by turning on a fan and allowing the resulting breeze to flow through the audience. The controlling of a fan, turning it on and off at the appropriate time or adjusting the speed, is controlled by an effects signal, effects track, timing data, manual signal, or other signal that is processed by an input system and sent to controller of this effects system. This input system could be include the effects system itself.

The signal is processed by the controller resulting in a device being turned on, turned off, or otherwise controlled or in the media presentation being altered or converted. This is typically done by providing power to or removing power from the device or by controlling it via an on/off or other signal. For a wind effect, one person might connect a window fan to the system. Someone else might use a ceiling fan. Someone else might use a spare standing fan. Whatever device the user connects is controlled by the system in order to produce the desired effect at the appropriate time. Rain or splashes can be experienced by connecting an electric squirt gun. Snow in a movie could be experienced by connecting an expensive artificial snow making machine or by connecting something as simple as a fan that blows cornstarch. A nighttime scene can be experienced by connecting a laser system to light a room with artificial stars or by connecting a light bulb inside a box with holes punched in it. Odors or fragrances, such as flowers on a hillside or the stench of a dungeon, can be experienced by connecting a small device with a fan that blows a fragrance toward the audience at an appropriate time. The possibilities are endless. The devices used to create these effects are a small example of many that could be created. This invention accommodates the control of these devices and/or the media presentation to produce media effects and a media experience that is more enjoyable and more memorable. This invention is comprised of both hardware and the software needed to make it function as desired and/or to present the media as desired.

### BRIEF DESCRIPTION OF THE SEVERAL VIEWS OF THE DRAWING

Having thus described the invention in general terms, reference will now be made to the accompanying drawings, which are not necessarily drawn to scale, and wherein:

FIG. 1. illustrates a boxed version of system with an optional DVD/Blu-Ray player. In this example, the front contains optional input buttons, an optional touch screen for system information and input, and an optional built-in video retrieval mechanism (in this case a DVD/Blu-Ray player). The control system and/or the controlled power supply could be could be built into various devices such as DVD Players, Blu-Ray Players, VCR, Media Devices, and even PCs. FIG. 1 also illustrates the inventions ability to receive either wired signals, or wireless signals, or both. Also illustrated are the various outputs such as alternating current (AC) voltages, direct current (DC voltages), controlled relays, and pulse-width modulated (PWM). The location or arrangement of the various modules and features is not necessarily important to its functionality. The wireless antenna, for example, could be on the back, on the front, internal to the system, or be achieved via an attachment.

FIG. 2. illustrates some of the various inputs to the control system. A primary input is computer software. For example, a media player application (to play media, video files, DVDs, Blu-Ray, video images, streaming video, simple audio files, etc.), plays the desired media presentation and sends the required effects signals or audio control signals to the control system. As illustrated, these effect and control signals can also be received from other media or mobile devices, streaming media systems, manual input, remote control, or some future device such as a holographic system.

FIG. 3. illustrates various examples of output from the control system. Alternating Current or AC voltages such as those received from a household electrical outlet, are common, but the invention allows for various AC voltages. Smaller AC voltages, for example, can be used for solenoid control. The invention also accommodates Direct Current or DC voltages as many smaller devices use DC. An example is glow plugs for pyrotechnics effects. Relays are typically used in items that are self-powered, but the relays in the invention do not limit relay connections to self-powered devices, and multiple outputs can be connected to a device (for example, for devices where on/off control is separate from power). Additionally, pulse-width-modulated [PWM], serial, and parallel signals are also controlled outputs. These can be used to activate or control many computerized or electronic devices. This invention is not limited to these types of outputs and the control system provides a means of controlling virtually any output type including an output type that might be created or invented in the future. There is no constraint in the system preventing the use or control of any particular output type. Although the processing of the effects signals can be done by the control system and firmware of the electronic circuitry, processing of effects signals and control signals is also done by the associated computer software (refer also to FIG. 2.). This helps facilitate the routing of effects signals and/or control signals to proprietary devices such as X10 and other remotely accessible systems so that they can be used to power on, power off, or otherwise control a device.

FIG. 4. illustrates a typical example of the workflow of the system. An input system, such as, but not limited to, external devices, software based systems, a remote device, a parallel system, those built into or integrated with the hardware, or any device or system capable of sending the required signal or data, sends an effects signal to the control system. In this example, the signal was “Wind 05:00->05:08”. The control signal or command is not limited to this form and may come in other forms. Such a signal may tell the control system to activate an output, turn on an effect, or turn on the device, such as a fan, while the user is five-minutes through five-minutes and eight seconds into the media presentation. Consequently, at approximately five minutes into the presentation, a fan connected to an output point might be turned on. About 8 seconds later, the connection point or device would turn off. Approximate values are used because the system does not have to be exact and may include time offsets to allow, for example, an effect to travel to the audience. A breeze, for example, may take a second or two to reach the audience so the corresponding connection point may need to be powered on and/or powered off a few seconds earlier than the control signal indicated. Any such time offset requirements can be configured and stored in the software system, control system, power distribution system, or some other associated system. All this is handled by the hardware, firmware, and/or application or media software systems. This figure also illustrates a typical example of devices that can be controlled by the system. AC devices include fans, vibrators or shakers, and fog machines. AC power could be used to heat the fog machine, the feedback connector could be used to tell the control system the fog machine is warmed and ready, while a relay could be used for actually turning it on. A common home consumer planetarium, which could be used for starry or night scenes, is a great example of a device that could be hooked up to a DC input. Many of the devices run using direct current power. A significant benefit of this invention is that an AC device, such as a lamp in a box with holes in it, could just as easily be connected to provide a means of achieving a starry or nighttime effect in a media presentation. PWM, serial, parallel, and other clock signals can be used to control devices such as LED lighting, flashing LED, and servos. Servos, for example, might need be used in order to rotate a water squirter back and forth while the squirter is activated. PWM signals might also be used to trigger motion systems to move seating.

FIG. 5. Illustrates various examples of ways in which effects tracks or media commands can be setup to trigger at the appropriate time. An effects track would be a list of effects, timing signals, and/or other media related commands that should occur or be executed before, during, or after a media presentation. This would typically be created by the software system of this invention which allows a user to view a media presentation and set effects, timing data, and media commands to accompany the presentation. These effect and command tracks would then be used and/or stored for use at the appropriate time. As illustrated, effects tracks could be shared and downloaded as needed from the internet. Additionally, they could be generated by analyzing the visual, audio, or textual portions of the media presentation either in real-time or prior to viewing the media presentation, illustrated by the analyze button within the software. As shown, the effects could also be triggered manually at the appropriate time via buttons, buttons on a touch screen, via a mobile media device, or some other form of control or remote control.

### DETAILED DESCRIPTION OF THE INVENTION

The present inventions now will be described more fully hereinafter with reference to the accompanying drawings, in which some examples of the embodiments of the inventions are shown. These inventions may be embodied in many different forms and should not be construed as limited to the embodiments set forth herein; rather, these embodiments are provided by way of example so that this disclosure will satisfy applicable legal requirements.

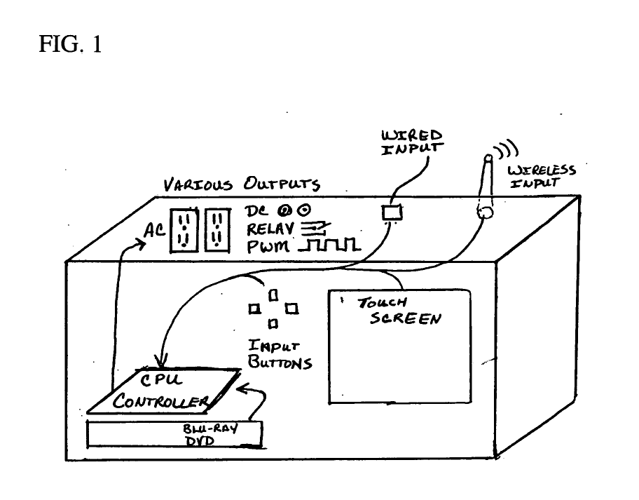

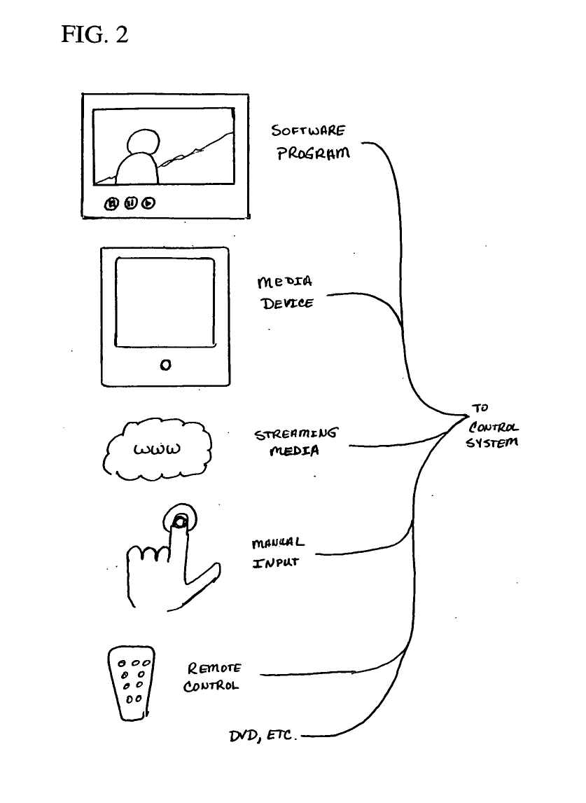

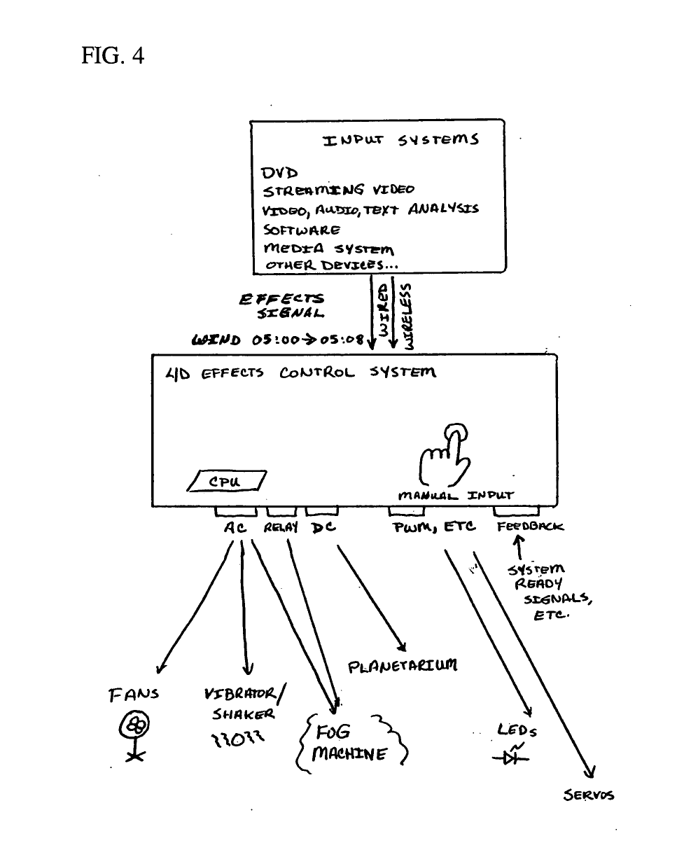

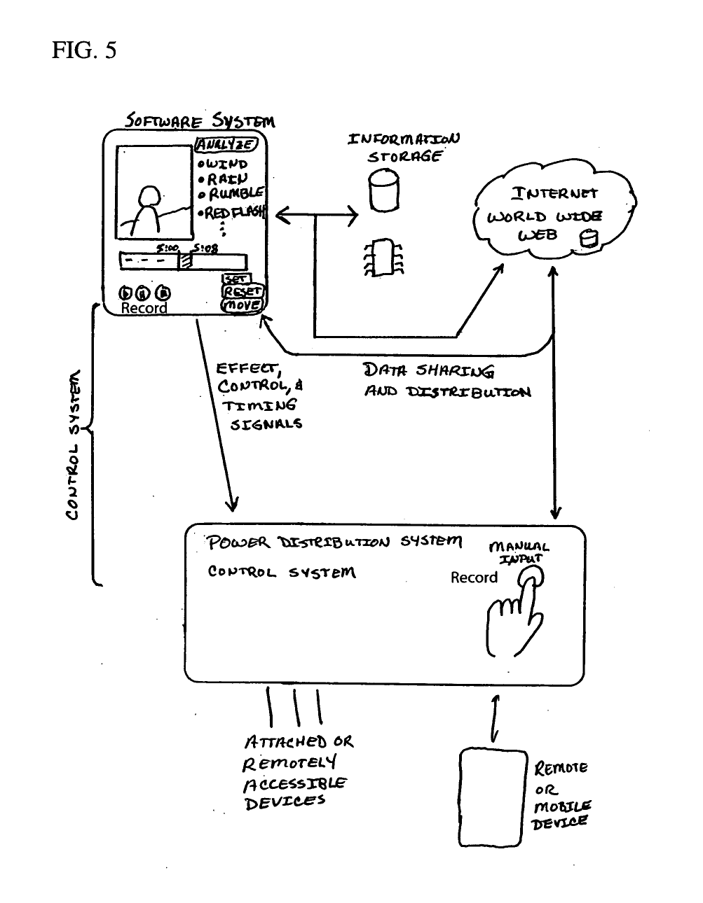

This invention consists primarily of a video, media, timer, or manual controlled power supply and/or software and hardware control system that processes a wired, wireless, timed, manual or other input signal associated with special effects in a video or media and the associated software for programming such features [FIG. 1, FIG. 4, FIG. 5]. The accompanying software system, or another of many possible system inputs [FIG. 2] provides the ability to create and/or use effects tracks or effects signals associated with a media presentation. Additionally, it can create or record processing commands that may alter the text or media presentation, skip portions of the media presentation, or jump to a position within the media presentation. The accompanying software system also has the ability to create, record, download, store, alter, share, or otherwise process the data it uses.

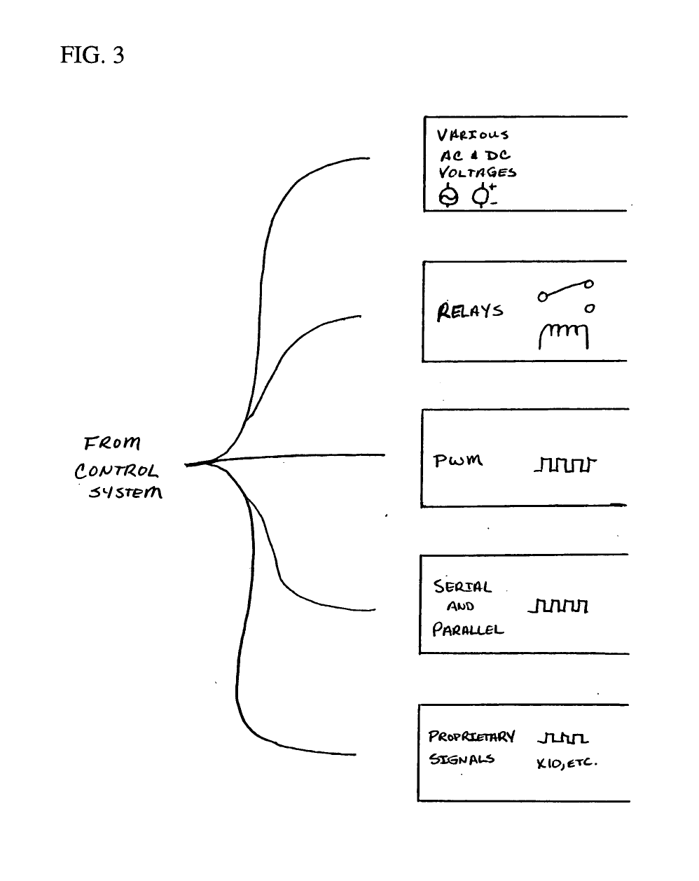

For example, a video might have a windy scene from 5:00 minutes to 5:08 minutes. This fact is typically pre-determined, but could be discovered via real-time analysis of the visual, audio, and textual elements of the media presentation. A signal is sent to the control system (or is generated within the control system) to be processed [FIG. 1, FIG. 2] and the control system turns on one of outlets or connection points [FIG. 3]. A device is powered or activated for this scene (a fan, for example, to simulate the wind from the movie). Full flow can be seen (from top to bottom) in FIG. 4. The user is able to use whatever device is at his disposal as the invention is controls AC and DC outlets, relays, PWM signals, and other connection points that allow virtually any device to be connected in order to achieve a particular tactile, sensory, or other effect (for example: snow, water, stars, odors/scents, rain, wind, lighting, shaking, fog, etc.) or to otherwise alter the media presentation. The effect information or signals sent to (or within) the control mechanism could be initiated from a variety of forms including, but not limited to, signals created and sent within the system, previously stored or recorded signals, manual or timed signals for media devices or systems that cannot send the appropriate signals, signals from video analysis, signals from audio track analysis, signals from subtitle or closed caption text analysis, signals from digital media, signals from a separate effects track, signals from streaming media, signals from a computer, signals from a software program, or signals from some future system (holographic processing system or some other futuristic device) [FIG. 5]. The signal could even be sent from within the invention or a derivative of the invention, for example, if the control mechanism or effects controlled power supply was incorporated into a device such as a DVD system, Blu-Ray system, projector, media system, or other such device. Manual signals could include examples such as activation of an effect via a remote, wired or wireless device, mobile device, or via a touch screen or buttons on or associated with the invention. Timed signals could come from within the invention or from an attached or remote input device.

The software system [FIG. 2], or any derivation of the software system, including systems which may implement a portion of the subset of features, also provides the user with the ability to setup, process, edit, or otherwise use commands that can jump to a different part of the media presentation, alter the media presentation, skip a portion of the media presentation, or alter the text of a media presentation. Some examples, though the invention should not be assumed to be constrained to or limited to this use, would be to replace text or audio (subtitles, closed caption, or other text) with an effect, to skip an undesired portion of the media presentation, or to alter or remove undesired audio or text from a portion of the media presentation.

The inventions have various AC, DC, Relay, PWM controls, and other programmable outlets and/or connection points. Various devices can be hooked up to the outlets and/or connection points to produce effects that are synchronized with a video or media presentation. For example, devices such as tactile transducers, shakers, or a vibrating device could be connected to the invention and used during scenes of tornadoes, earthquakes, crashes, etc. For night or starry scenes, a user could connect various devices such as a laser star-field projector or something as simple as a do-it-yourself homemade planetarium shoebox with a light in it and holes poked in the box to allow starlight dots to be produced.

One uniqueness of this invention is that virtually any device can be connected to and controlled by the system to achieve a particular effect. This is, in part, due to the fact that power, voltages, relays, PWM signals, and other connection points are programmable and are controlled by sources such as video, digital media, mobile devices, DVD players, VCRs, projects, holographic projection devices, and other devices. An effect control signal or command can be setup to control one or more outlets which can be assigned to one or more output devices of the users choice such as fans, fog machines, shakers, etc.

The invention is also modular and can be incorporated into media devices either in whole or in part. FIG. 1. illustrates either the invention being incorporated into a DVD player, or alternatively, a DVD player incorporated into the invention. Either way, the final result is the essentially the same; whereas, the invention, as illustrated in FIG. 4., is a standalone unit with possible inputs from various external or internal devices.

This invention can be incorporated into a digital media system (DVD, Blu-Ray, Media Player, etc.) [FIG. 1, FIG. 5] that could then download, read from media, read from a memory device, or get from its own memory or storage system effects signals, control signals, and timing data for a media presentation, process the signals, and control attached or internal devices accordingly. Consequently, in the future, a person could possibly buy a DVD player that would have been built “4D capable”. The invention could be incorporated into the media system itself or the effects processing portion could be incorporated and setup to control power in an external system [FIG 6]. The invention is modular and the software control system, hardware control system, and power control system can be separated to function more or less independent of each other (being connected to an alternative system in lieu of being integrated).

1. A method of using media to turn on power, turn off power, activate, deactivate, or in some other way control connected devices, comprising:
a. providing said media or data associated with said media and constructing, extracting, or using a signal or command from said media or from said associated data, or using a portion of the said media or said associated data as a command,
b. processing said signal or command as a means of providing power to, removing power from, activating, de-activating, or in some other way controlling an attached or remote device,
whereby, said media and/or said associated data can be used to power, activate, or control said attached or remote devices, common household items, appliances, or custom built creations.

2. A media controlled power distribution system, comprising:
a. a control system or power distribution system that processes said media and/or associated data to control connected devices and/or to provide commands to a media system, another control system, and/or a power distribution system,
b. means for said media to distribute power via said power distribution system and/or to control devices that are directly or remotely attached to the said system,
whereby, said system will use said media and/or its associated data to provide power or control over a connected or remotely connected device at a time associated with a media presentation.

3. The control system or power distribution system of claim 2 where the input to the control system may be wired or wireless and could be received from, but is not limited to receiving input from the said system itself, a software application, media analysis, a media or mobile device, streaming media software, a streaming media system, the world wide web (internet), other control systems, manual input, timed input, stored data, remote control, or some future device such as a holographic system.

4. The control system or power distribution system of claim 2 where input signals may include but are not limited to signals created or sent within the system, signals created by manual input, timed signals, signals from video analysis, signals from audio analysis, signals from subtitle analysis, signals from closed caption analysis, signals from analyzing other text, data, or metadata associated with the said media, signals from digital media, signals from a separate effects track, signals from or associated with streaming media, signals from a computer, signals from a software program or system, or signals from some future system such as a holographic display or processing system or some other futuristic device.

5. The control system or power distribution system of claim 2 where said devices may be attached directly or indirectly to the system or may be remotely accessible.

6. The control system or power distribution system of claim 2 where said devices may be connected to the system or remotely accessible by the system via either wired or wireless control.

7. The control system or power distribution system of claim 2 where said control system has a means of assigning one or more connection points to an effect or command signal or to leave connection points unassigned.

8. The control system or power distribution system of claim 2 where said systems have a means of translating or converting video or digital media into a multi-sensory 4D experience by using commands, effects, and/or timing signal and using them to power on, power off, or otherwise control a connected device or media presentation.

9. The control system or power distribution system of claim 2 where the said control system has a means of creating or recording effects signals, timing signals, and media control signals.

10. The control system or power distribution system of claim 2 where the said systems can be separated and used in whole or in part providing a means of an external power distribution system to be used in lieu of an integrated power distribution system or an external control system to be used in lieu of an integrated control system.

11. The control system or power distribution system of claim 2 where the said control system or said power distribution system can receive and process feedback from an attached device.

12. A machine that uses a general purpose data processor to add effect, language processing information, media processing information, and/or command data to media and/or facilitates the means of creating media data or associated media data that can be stored, shared, or used by a control system or power distribution system.

13. The machine of claim 12 where it has a means of adding command data to media and/or to create associated media data as a means to facilitate control of a media presentation by skipping undesired portions of a media presentation and/or modify portions of the media presentation during playback.

14. The machine of claim 12 where it has a means of to scan closed caption, subtitles, audio, video, and/or other media or associated media data to automatically or systematically produce effects tracks or data and media command data as a means of facilitate faster use of said media or said associated media data in order to create commands that can be used to control a media system, control a media playback experience, and/or to pass control information to a processing system that can use the said control information to perform an intended action or effect.

15. The machine of claim 12 where it has a means of sharing media effect data and command sets with other users or systems, comprising:
a. the uploading of said data to a data server,
b. facilitating the download of said data that can be used be a media presentation system,
whereby said machine provides a means of sharing said media effect data or said command set data of one user or system with another user or system.

16. The machine of claim 12 where it has a means of distributing media effect data and media command data to users and systems, comprising:
a. creating, loading, or retrieval of said media effect data and said command set,
b. providing a means of storing said media effect data or said command set data in a location where it can be used or retrieved by users or systems,
whereby said control system or said power distribution system or a media processing or media presentation system or said machine is able to install or use said data.

17. The machine of claim 12 where it has a means of creating or recording effects signals and data, timing signals and data, and media control signals and data during playback or for use during playback of said media presentation.
